(19) United States
(12) Patent Application Publication
(10) Pub. No.: US 2014/0172348 A1
(43) Pub. Date: Jun. 19, 2014

(54) THERMAL TEST DETERMINING SYSTEM AND METHOD FOR SERVER

(71) Applicant: HON HAI PRECISION INDUSTRY CO., LTD., New Taipei (TW)

(72) Inventors: CHENG-HSIU YANG, New Taipei (TW); YI-TING LIU, New Taipei (TW)

(73) Assignee: HON HAI PRECISION INDUSTRY CO., LTD., New Taipei (TW)

(21) Appl. No.: 13/873,259

(22) Filed: Apr. 30, 2013

(30) Foreign Application Priority Data
Dec. 14, 2012 (TW) 101147691

(51) Int. Cl. G01K 13/00

(52) U.S. Cl. CPC G01K 13/00
USPC 702/130

(57) ABSTRACT

A thermal test determining method is executed by a computing device to set a preset test time of each thermal test of a server. To-be-monitored channels of the server are selected. A fan rotation speed for each thermal test is set. In each thermal test, a control command is transmitted to the server to control fans to work according to the fan rotation speed. The temperature of each to-be-monitored channel is obtained from the temperature recorder. A reference temperature is selected from N obtained temperatures of each to-be-monitored channel. The reference temperature is compared with each temperature obtained after the reference temperature. The server is determined to has reached temperature equalization if each comparison result is not greater than a preset value, and the actual test time of each thermal test is not greater than the preset test time. A related computing device and storage medium is also provided.

### BACKGROUND

1. Technical Field

The present disclosure relates to thermal test determining systems and methods and, particularly, to a thermal test determining system and method for determining whether a server reaches temperature equalization in a thermal test.

2. Description of Related Art

Typically, in a thermal test of a server, engineers need to determine whether the server reaches temperature equalization according to temperatures recorded by a temperature recorder. Accordingly, the probability of manual human error is high. Therefore, there exists a need to provide a system and method to automatically determine a test result of each thermal test of a server.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram to show how to do a thermal test of a server, in accordance with an exemplary embodiment.

FIG. 2 is a block diagram of function modules of a thermal test determining system of FIG. 1, in accordance with an exemplary embodiment.

FIG. 3 is a flowchart of a thermal test determining method, in accordance with an exemplary embodiment.

### DETAILED DESCRIPTION

Embodiments of the present disclosure will now be described in detail, with reference to the accompanying drawings.

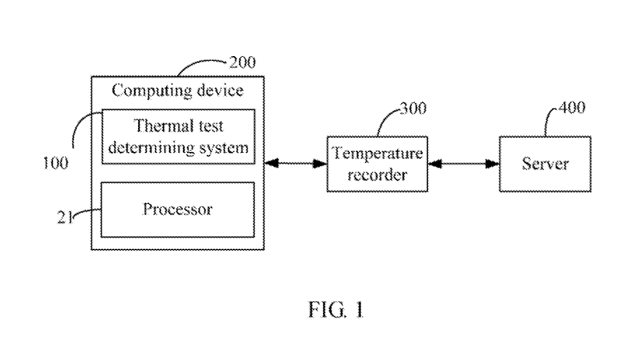

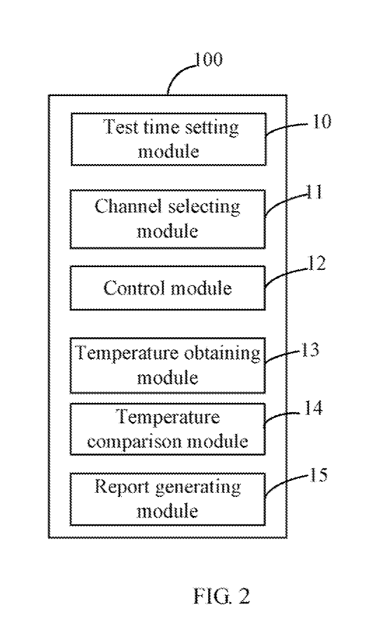

Referring to FIGS. 1-2, a thermal test determining system 100 is executed by a processor 21 of a computing device 200 (e.g. computer) to determine whether a server 400 reaches temperature equalization in a thermal test according to temperatures recorded by a temperature recorder 300. The computing device 200 is connected to the server 400 and the temperature recorder 300. The temperature recorder 300 is further connected to the server 400 to record temperatures of different channels of the server 400 in each thermal test. The system 100 includes a test time setting module 10, a channel selecting module 11, a control module 12, a temperature obtaining module 13, a temperature comparison module, and a report generating module 15.

The test time setting module 10 sets a preset test time of each thermal test of the server 400. Each thermal test of the server 400 should finish within the preset test time.

The channel selecting module 11 selects to-be-monitored channels of the server 400. In this embodiment, the to-be-monitored channels are the channels which temperature will undergo a great change in each thermal test.

The control module 12 sets a fan rotation speed for each thermal test, and in each thermal test, transmits a control command to the server 400 to control fans of the server 400 to work according to the fan rotation speed.

The temperature obtaining module 13 obtains the temperature of each to-be-monitored channel from the temperature recorder 300 every a preset period in each thermal test.

The temperature comparison module 14 selects one temperature as a reference temperature from N obtained temperatures of each to-be-monitored channel, and compare the reference temperature with each temperature obtained after the reference temperature. In this embodiment, a difference between each two adjacent temperatures obtained before the reference temperature is greater than a difference between each two adjacent temperatures obtained after the reference temperature. In other words, the temperature comparison module 14 selects the temperatures obtained after the thermal test has carried out a period of time. At the beginning of the thermal test, the temperatures of each to-be-monitored channel changes greatly. After the thermal test has carried out a period of time, the server 400 gradually reaches the temperature equalization. Thus, selecting the temperatures obtained after the thermal test has carried out a period of time can increase the accuracy of determination.

If each comparison result from the temperature comparison module 14 is not greater than a preset value, and the actual test time of each thermal test is not greater than the preset test time, the control module 12 determines that the server 400 has reached the temperature equalization, finishes the current thermal test, and controls the server 400 to do a next thermal test. If one comparison result is greater than the preset value, the control module 12 determines that the server 400 cannot reach the temperature equalization in the current thermal test, finishes the current thermal test, and controls the sever 400 to do a next thermal test.

The report generating module 15 generates a report recording test result after the control module 12 finishes the current thermal test.

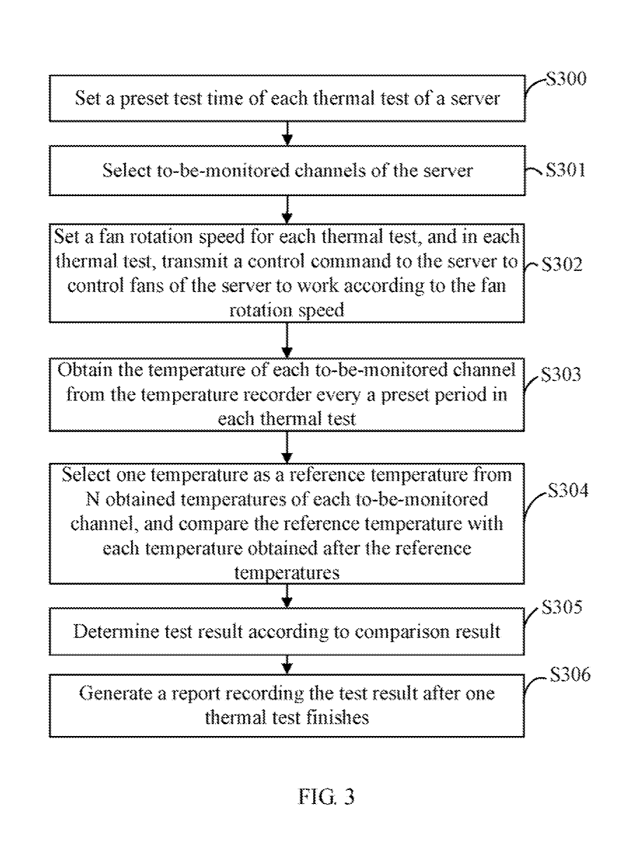

FIG. 3 is a flowchart of a thermal test determining method, in accordance with an exemplary embodiment.

In step S300, the test time setting module 10 sets a preset test time of each thermal test of the server 400.

In step S301, the channel selecting module 11 selects to-be-monitored channels of the server 400.

In step S302, the control module 12 sets a fan rotation speed for each thermal test, and in each thermal test, transmits a control command to the server 400 to control fans of the server 400 to work according to the fan rotation speed.

In step S303, the temperature obtaining module 13 obtains the temperature of each to-be-monitored channel from the temperature recorder 300 every a preset period in each thermal test.

In step S304, the temperature comparison module 14 selects one temperature as a reference temperature from N obtained temperatures of each to-be-monitored channel, and compare the reference temperature with each temperature obtained after the reference temperatures.

In step S305, if each comparison result from the temperature comparison module 14 is not greater than a preset value, and the actual test time of each thermal test is not greater than the preset test time, the control module 12 determines that the server 400 has reached the temperature equalization, finishes the current thermal test, and controls the server 400 to do a next thermal test, and if one comparison result is greater than the preset value, the server 400 determines that the server 400 cannot reach the temperature equalization in the current thermal test, finishes the current thermal test, and controls the sever 400 to do a next thermal test.

In step S306, the report generating module 15 generates a report recording test result after the control module 12 finishes the current thermal test.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A computing device connected to a server and a temperature recorder, the temperature recorder being connected to the server to record temperatures of channels of the server, the computing device comprising:
a processor; and
a plurality of modules executable by the processor, the plurality of modules comprising:
a channel selecting module operable to select to-be-monitored channels of the server;
a control module operable to set a fan rotation speed for each thermal test, and in each thermal test, transmit a control command to the server to control fans of the server 400 to work according to the fan rotation speed;
a temperature obtaining module operable to obtain the temperature of each to-be-monitored channel from the temperature recorder every a preset period in each thermal test; and
a temperature comparison module operable to select one temperature as a reference temperature from N obtained temperatures of each to-be-monitored channel, and compare the reference temperature with each temperature obtained after the reference temperature;
wherein, the control module is further operable to determine that the server has reached temperature equalization, finish the current thermal test, and control the server to do a next thermal test if each comparison result from the temperature comparison module is not greater than a preset value, and the actual test time of each thermal test is not greater than the preset test time.

2. The computing device as described in claim 1, wherein the control module is further operable to determine that the server cannot reach the temperature equalization in the current thermal test, finish the current thermal test, and control the sever to do a next thermal test if one comparison result is greater than the preset value.

3. The computing device as described in claim 1, wherein the plurality of modules further comprises a report generating module operable to generate a report recording test result after the control module finishes the current thermal test.

4. The computing device as described in claim 1, wherein the to-be-monitored channels are the channels which temperature will undergo a great change in each thermal test.

5. The computing device as described in claim 1, wherein a difference between each two adjacent temperatures obtained before the reference temperature is greater than a difference between each two adjacent temperatures obtained after the reference temperature.

6. A thermal test determining method to be executed by a processor of a computing device, the computing device being connected to a server and a temperature recorder, the temperature recorder being connected to the server to record temperatures of channels of the server, the method comprising:
setting a preset test time of each thermal test of the server;
selecting to-be-monitored channels of the server;
setting a fan rotation speed for each thermal test, and in each thermal test, transmit a control command to the server to control fans of the server to work according to the fan rotation speed;
obtaining the temperature of each to-be-monitored channel from the temperature recorder every a preset period in each thermal test;
selecting one temperature as a reference temperature from N obtained temperatures of each to-be-monitored channel, and compare the reference temperature with each temperature obtained after the reference temperature; and
determining that the server has reached temperature equalization, finish the current thermal test, and control the server to do a next thermal test if each comparison result is not greater than a preset value, and the actual test time of each thermal test is not greater than the preset test time.

7. The thermal test determining method as described in claim 6, further comprising:
determining that the server cannot reach the temperature equalization in the current thermal test, finish the current thermal test, and control the sever to do a next thermal test if one comparison result is greater than the preset value.

8. The thermal test determining method as described in claim 6, further comprising:
generating a report recording test result after the control module finishes the current thermal test.

9. The thermal test determining method as described in claim 6, wherein the to-be-monitored channels are the channels which temperature will undergo a great change in each thermal test.

10. The thermal test determining method as described in claim 6, wherein a difference between each two adjacent temperatures obtained before the reference temperature is greater than a difference between each two adjacent temperatures obtained after the reference temperature.

11. A non-transitory storage medium storing a plurality of modules, the plurality of modules comprising instructions executable by a processor of a computing device to perform a thermal test determining method, the computing device being connected to a server and a temperature recorder, the temperature recorder being connected to the server to record temperatures of channels of the server, the method comprising:
setting a preset test time of each thermal test of the server;
selecting to-be-monitored channels of the server;
setting a fan rotation speed for each thermal test, and in each thermal test, transmit a control command to the server to control fans of the server to work according to the fan rotation speed;
obtaining the temperature of each to-be-monitored channel from the temperature recorder every a preset period in each thermal test;
selecting one temperature as a reference temperature from N obtained temperatures of each to-be-monitored channel, and compare the reference temperature with each temperature obtained after the reference temperature; and
determining that the server has reached temperature equalization, finish the current thermal test, and control the server to do a next thermal test if each comparison result is not greater than a preset value, and the actual test time of each thermal test is not greater than the preset test time.

12. The storage medium as described in claim 11, wherein the method further comprising:
determining that the server cannot reach the temperature equalization in the current thermal test, finish the current thermal test, and control the sever to do a next thermal test if one comparison result is greater than the preset value.

13. The storage medium as described in claim 11, wherein the method further comprising:
generating a report recording test result after the control module finishes the current thermal test.

14. The storage medium as described in claim 11, wherein the to-be-monitored channels are the channels which temperature will undergo a great change in each thermal test.

15. The storage medium as described in claim 11, wherein a difference between each two adjacent temperatures obtained before the reference temperature is greater than a difference between each two adjacent temperatures obtained after the reference temperature.
